(19) United States
(12) Patent Application Publication
(10) Pub. No.: US 2012/0164570 A1
(43) Pub. Date: Jun. 28, 2012

(54) THERMALLY CONDUCTIVE FUSER COATING

(76) Inventors: Jerry Alan Pickering, Hilton, NY (US); Jason Morgan, Appleton, WI (US)

(21) Appl. No.: 12/975,780

(22) Filed: Dec. 22, 2010

(51) Int. Cl. G03G 13/20; G03G 15/20

(52) U.S. Cl. 430/124.33; 399/335

(57) ABSTRACT

The present invention is directed towards a fuser member having as its outermost layer, a cured composite comprising: a) a continuous phase of an elastomer; and b) thermally conductive particles dispersed in the elastomer, where the conductive particles comprise inorganic particles coated with a layer of fluoroplastic.

### FIELD OF THE INVENTION

The present invention relates to fuser members and thermally conductive particles employed in coatings of such fuser members.

### BACKGROUND OF THE INVENTION

The present invention relates to electrostatographic imaging and recording apparatus, and to assemblies in these apparatus for fixing toner to the substrates. The present invention relates particularly to fuser members, and fusing surface layers for fuser members, in the toner fixing assemblies.

Generally in electrostatographic reproduction, the original to be copied is rendered in the form of a latent electrostatic image on a photosensitive member. This latent image is made visible by the application of electrically charged toner.

The toner forming the image is transferred to a substrate, also referred to in the art as a “receiver”, such as paper or transparent film, and fixed or fused to the substrate. Where heat softenable toners, for example, thermoplastic polymeric binders, are employed, the usual method of fixing the toner to the substrate involves applying heat to the toner once it is on the substrate surface, to soften it and then allowing or causing the toner to cool. This application of heat in the fusing process is at a preferred temperature of about 90° C.-220° C.; pressure may be employed in conjunction with the heat.

A system or assembly for providing the requisite heat and pressure is generally provided as a fusing subsystem, and customarily includes a fuser member and a support member. The various members that comprise the fusing subsystem are considered to be fusing members; of these, the fuser member is the particular member that contacts the toner to be fused by the fusing subsystem. The heat energy employed in the fusing process is generally transmitted to toner on the substrate by the fuser member. Specifically, the fuser member is heated to transfer heat energy to toner situated on a surface of the substrate. The fuser member contacts this toner, and correspondingly also can contact this surface of the substrate itself. The support member contacts an opposing surface of the substrate.

Accordingly, the substrate can be situated or positioned between the fuser and support members so that these members can act together on the substrate to provide the requisite pressure in the fusing process. In cooperating, preferably the fuser and support members define a nip, or contact arc, through which the substrate passes. Preferably, the fuser and support members are in the form of fuser and pressure rollers, respectively. Yet additionally one or both of the fuser and support members have a soft layer that increases the nip to facilitate better transfer of heat to fuse the toner.

During the fusing process toner can be offset from the substrate to the fuser member. Toner transferred to the fuser member in turn may be passed on to other members in the electrostatographic apparatus or to subsequent substrates subjected to fusing.

Toner on the fusing member, therefore, can interfere with the operation of the electrostatographic apparatus and with the quality of the ultimate product of the electrostatographic process. This offset toner is regarded as contamination of the fuser member. Therefore, improving the release of the fuser member fusing surface layer, and thereby preventing or at least minimizing this contamination is a desirable objective.

A factor in achieving sufficient fusing quality is providing sufficient heat transfer from the fusing surface layer of the fuser member to the substrate toner. This heat transfer is improved by increasing the fusing surface layer's thermal conductivity, which in turn is increased by incorporating thermally conductive filler in this layer. Particularly, high speed fusing of thermoplastic toners can require the presence of thermally conductive filler in the fusing surface layer, in order to increase the thermal conductivity of this layer. Unfortunately, thermally conductive fillers are characterized by high surface energy; because of this property they serve as sites for toner to adhere to. These sites remove toner from the substrate and the displaced toner contaminates the fuser member surface. Polyester toners in particular are especially prone to interacting with high energy sites in this manner to cause such contamination.

Heavily filled silicone rubber, used for fuser member surfaces, is known to produce high quality fused images. The polysiloxane elastomers have relatively low surface energies and also relatively low mechanical strengths, but are adequately flexible and elastic. Unfortunately, silicone rubbers wear easily when employed for this purpose; after a period of use, the action of the paper or other media passing through a high pressure nip wears a polysiloxane elastomer fuser surface. The silicone rubbers' low wear resistance as fuser member surfaces accordingly limits fuser member life. Further, although treatment with a polysiloxane release fluid during use of the fuser member enhances its ability to release toner, the fluid causes the silicone rubber to swell. This fluid absorption is a particular factor that shortens fuser member life; fluid treated portions tend to swell and wear and degrade faster. Fuser members with polysiloxane elastomer fusing surfaces accordingly have a limited life.

Fluorocarbon materials also have low surface energies, and, like silicone rubbers, are used as release surface materials for fuser members. Polyfluorocarbons employed for this purpose include nonelastomeric fluorocarbon materials, or fluoroplastics, and fluoro-elastomer materials. However, there are disadvantages associated with the use of both.

The fluorocarbon resins like polytetra-fluoroethylene (PTFE), and copolymers of tetrafluoroethylene (TFE) and perfluoroalkylvinylether (PFA), and fluorinated ethylene propylene copolymers (FEP), have excellent release characteristics due to very low surface energies. They also are characterized by high temperature resistance, excellent resistance to chemical interaction, and low wear (high abrasion resistance). However, these materials are particularly susceptible to offset, due to high modulus and poor surface contact with rough substrates. Fluorocarbon resins also are less flexible and elastic than polysiloxane elastomers, and are unsuitable for producing high image quality images.

Additionally, fluorocarbon resins, having the indicated typically high modulus, cannot evenly contact rough papers, as noted. Therefore, they provide varying gloss within the same image. This gloss variation may be referred to as mottled gloss. The poor contact, related (as indicated) to high modulus, also tends to produce images with objectionable offset. Specifically, with a high modulus there will be objectionable mottled gloss as well as objectionable offset. Contact may be improved by the use of a thin fusing surface layer; however, a surface sleeve is limited to a certain minimum thickness when used in conjunction with an underlying soft cushion, because repeated compression results in sleeve wrinkling.

Fluoroelastomers, besides their low surface energy as indicated, have excellent wear resistance as fusing member surfaces. They provide better durability in this regard than the polysiloxane elastomers, and unlike the silicone rubbers, do not swell when in contact with polysiloxane release fluids. However, fluoroelastomers have less resistance to chemical interaction than either silicones or fluoroplastics, and typically must be used in conjunction with reactive release fluids. As release fluids are subject to disruption or failure, fluoroelastomers are at risk of irreversible contamination.

Inorganic fillers have been incorporated into fluoroelastomer surface layers to achieve the desired combination of properties like wear resistance, modulus, and thermal conductivity. Particularly, it is known that certain fillers may be used to reinforce the elastomer and further enhance the wear resistance of fluoroelastomers. However, it is also known that the presence of inorganic filler particles, in the fluoroelastomer fusing surface layers of fuser members, provides high-energy sites for removing toner from the substrate. In addition, inorganic fillers are typically extremely hard and abrasive to other elements of the toner fusing system that contact the fuser member.

It is known to use PIPE as filler for a fusing surface layers. With PTFE and similar fluororesins being recognized as having low adhesion, good chemical resistance, and low coefficients of friction, there have been many attempts to combine these fluororesins with other materials used in fusing surface layers. For instance, U.S. Pat. Nos. 3,669,707 and 3,795,033 disclose a fuser roller having a silicone elastomer surface that incorporates fluorinated resin filler, such as fibrillatable polytetrafluoroethylene powder. U.S. Pat. No. 4,568,275 discloses a fuser roller with a surfacial layer prepared from an aqueous dispersion comprising fluorinated rubber and fluorinated resin. U.S. Pat. No. 5,376,996 discloses a fuser roller with a coating comprising a mixture of polyphenylene sulfide and polytetrafluoro-ethylene. U.S. Pat. No. 5,547,742 discloses a fuser roller having a surface layer comprising a fluorosilicone rubber and 5 to 50 weight percent of a fluororesin, such as polytetrafluoroethylene.

Further, U.S. Pat. No. 4,503,179 discloses an aqueous fluorine-containing rubber coating composition comprising a fluorine-containing rubber, a fluorine-containing resin, and an aminosilane. U.S. Pat. Nos. 4,555,543 and 5,194,335 disclose a film forming fluid coating or casting composition, comprising fluoroplastic resin dispersion modified by a fluoroelastomer latex. U.S. Pat. No. 6,239,223 discloses a blended solid composition comprising a fibrillatable microparticulate polytetrafluoroethylene and a fluoroelastomer; also disclosed is a blended solid composition comprising a low molecular weight, nonfibrillatable polytetrafluoroethylene and a fluoroelastomer, wherein the nonfibrillatable polytetrafluoroethylene is present at greater than 35 percent by weight, based on total polymer solids of the composition.

Fluoroplastic resin fillers as employed in such previous disclosures, however, have only marginal thermal conductivity.

It would be desirable to provide for enhancing the thermal conductivity of fuser member layers by incorporation of thermally conductive inorganic filler particles, while reducing toner offset typically associated with use of such thermal filler particles.

### SUMMARY OF THE INVENTION

The present invention is directed towards a fuser member having as its outermost layer, a cured composite comprising: a) a continuous phase of an elastomer; and b) thermally conductive particles dispersed in the elastomer, where the conductive particles comprise inorganic particles coated with a layer of fluoroplastic.

### DESCRIPTION OF THE INVENTION

The invention pertains to a fuser member for a toner fusing system or process, with the fuser member typically comprising a base and an outermost layer overlaying the fuser base, as a fusing surface layer. Preferably, the thermally conductive particles are dispersed uniformly in the elastomer of the outermost layer. This fusing surface layer can reside directly on the fuser base. Alternatively, there can be one or more materials and/or layers, including one or more cushion layers, interposed between the fuser base and the fusing surface layer. The fusing surface layer of the invention is characterized by excellent wear and excellent release.

Fusing or operating temperatures, or the temperature of the fusing process, is understood as being within the range of from about 90° C. to about 250° C.

The preferred temperatures are generally within the range of from about 120° C. to about 200° C., more preferably from about 150° C. to about 185° C., still more preferably from about 160° C. to about 180° C.

Copolymers are understood as including polymers incorporating two different monomeric units, i.e., bipolymers, as well as polymers incorporating three or more different monomeric units, e.g., terpolymers, quaterpolymers, etc.

Elastomers are understood as including polymers that are nonelastomeric at room temperature but elastomeric at fusing or operating temperatures.

The outermost layer of the invention comprises fluoroplastic coated thermally conductive inorganic particles. Preferably, the particles are dispersed uniformly in the elastomer layer. Especially, the particles preferably are uniformly, or at least essentially uniformly, dispersed in the layer correspondingly, preferably dispersed uniformly, or at least essentially uniformly, in the elastomer. And further as a matter of preference, this uniform, or at least essentially uniform dispersion is such that surface preparation, surface finishing, wear during use, or other abrasion, results in the same composition at the surface of the layer.

Thermally conductive inorganic particles employed in the present invention typically will have a thermal conductivity of at least 0.5 Watts/mK. Suitable thermally conductive fillers include, e.g., SnO₂, SiC, CuO, ZnO, FeO, Fe₂O₃, BN, crystalline SiO₂, TiO₂, and Al₂O₃. Preferred thermally conductive fillers are Al₂O₃ and Fe₂O₃.

These thermally conductive particles may be present i.e., dispersed through the elastomer in amounts and proportions, and sizes, as are generally known or as can be determined without undue experimentation by those of ordinary skill in the art. Thermally conductive filler in particular preferably comprises not more than about 45 percent by volume, more preferably not more than about 40 percent by volume, more preferably not more than about 35 percent by volume, still more preferably not more than about 30 percent by volume of the fusing surface layer. Still more preferably, filler as indicated comprises from about 5 percent by volume, or from about 10 percent by volume, to about 45 percent by volume, of the fusing surface layer.

The thermally conductive particles may be in one or more of any suitable shapes irregular, as well as in the form of spheroids, platelets, flakes, powders, ovoids, needles, fibers, and the like. Where the fuser member is for use with a fusing system where internal heating is employed, an irregular shape is more preferred, as are spherical particles and platelets, so as to maximize the heat conducting effect of the filler particles; fibers, needles, and otherwise elongated shapes are less preferred here, unless they are advantageously oriented, because in certain alignments they are less effective for properly conducting heat.

In this regard, elongated thermally conductive particles are more efficient for conducting heat in the proper direction if they are at right angles to the fuser base radially aligned, if the fuser base is a cylindrical core, belt on rollers, or a core-mounted plate, but less efficient if they are positioned parallel to the core axially aligned, if the fuser base is a core, a belt, or is core mounted as indicated. Accordingly, to maximize heat conducting properties where elongated thermally conductive particles are employed, perpendicular (radial) positioning is preferred, while parallel (axial) alignment may be employed but is not preferred.

Particularly as to sizes, preferably the thermally conductive particles have a mean particle diameter of from about 0.1 microns, or from about 0.2 microns, to about 20 microns, or to about 50 microns, or to about 80 microns. For application where a smooth surface is desired, the particle size is preferred to be between about 0.1 and 25 microns, more preferably about 0.1 to 18 microns, still more preferably between about 0.1 and 12 microns. Where a rough surface is desired, the particle size is preferred to be between about 12 microns and 80 microns, more preferably between about 18 and 60 microns, and more preferably between about 25 and 60 microns.

Thermally conductive inorganic particles employed in accordance with the present invention are coated with a layer of fluoroplastic prior to being dispersed in the outermost layer elastomer. Fluoroplastics for use in coating the thermally conductive inorganic particles may include, e.g., perfluorocarbons, fluorohydrocarbons, and perfluorocarbons containing one or more fluorinated or non-fluorinate monomers. These include polytetrafluoroethylenes (PTFE), and fluorinated ethylene propylenes (FEP), including copolymers of tetrafluoroethylene and hexafluoropropylene, as well as copolymers of tetrafluoroethylene and ethylene, and copolymers of tetrafluoroethylene and perfluoroalkyl vinyl ether (PFA). Suitable fluoroplastics, or fluororesins, have a number average molecular weight of from about 1,000 to about 10,000,000.

Coating of the inorganic particles with a fluoroplastic may be by solution coating (e.g., TEFLON AF dissolved in a fluorosolvent which is applied to the inorganic thermal filler particles and dried), or by sintering (sub-micron PTFE powder, e.g., may be blended with the inorganic filler particulate and sintered at 700 F to melt the fluoroplastic onto the inorganic particulate. The coated filler may then be redispersed and combined with the elastomer to form the outermost layer.

In various embodiments, the fluoroplastic coating can comprise up to 30 percent of the coated filler, up to 50 percent, or up to 75 percent by weight of the coated filler. The fluoroplastic coating is preferably between about 5 parts fluoroplastic and about 50 parts fluoroplastic per 100 parts of inorganic filler, more preferably between about 10 parts fluoroplastic and about 50 parts fluoroplastic per 100 parts of inorganic filler. The resulting mixture after drying or sintering can require milling or de-agglomeration, particularly at higher levels of fluoroplastic. Agitation during the drying or sintering process can help minimize agglomeration. Sieving after the de-agglomeration process may also be desirable.

Fluoroplastics have low surface energy, and correspondingly the fluoroplastic coated inorganic particles have a lower propensity for removing toner from the substrate. The fluoroplastic coatings may further impart improved wear resistance to fusing surface layers.

Further regarding the fluoroplastic coating, polytetrafluoroethylenes including one or more additional monomers in minor amounts, such as up to about 5 mole percent, may be used. Suitable such additional monomers include fluorocarbons, chlorocarbons, hydrofluorocarbons, hydrochlorocarbons, fluoroethers, and hydrofluoroethers, and particularly perfluoroalkylvinylethers. Specific examples are hexafluoropropylene and n-perfluoropropylvinylether.

Particularly preferred polytetrafluoroethylenes, including those comprising one or more additional monomers in minor amounts, such as up to about 5 mole percent are those having a molecular weight of from above about 25,000 to about 250,000. Polytetrafluoroethylenes in this molecular weight range i.e., which can be referred to as low molecular weight (LMW) PTFE are desirable due to their low cost, and their availability in various particle sizes, and dry powder form. A method for preparing LMW PTFE from higher molecular weight polytetrafluoroethylene is by gamma or electron beam irradiation of the latter, such as disclosed in U.S. Pat. No. 5,846,447 and Great Britain Patent Specification No. 1,354,471, which are incorporated herein in their entireties, by reference thereto. Another method, as discussed herein, is by mechanical shear degradation of the higher molecular weight polytetrafluoroethylene. Commercially available LMW polytetrafluoroethylenes, which are suitable for use in the present invention, include the following: ZONYL MP1100, MP1000, and MP 1300, from DuPont Fluoroproducts, Wilmington, Del.; DYNEON 9207, from Dyneon L.L.C., Oakdale, Minn.; ALGOFLON FSA EX, from Ausimont USA, Inc., Thorofare, N.J.; and M270 and M290, from Shamrock Technologies Inc., Newark, N.J.

The fluoroplastic coated thermally conductive inorganic particles are dispersed into an elastomer. Elastomers that are useful in the present invention include silicone elastomers and fluoroelastomers. In a preferred embodiment, a fluoroelastomer is employed, including, e.g., fluorosilicone elastomers, fluorocarbonelastomers, perfluoroelastomers, and perfluoropolyether elastomers.

Suitable fluoroelastomers for the fusing surface layer include random polymers comprising two or more monomeric units, with these monomeric units comprising members selected from a group consisting of vinylidene fluoride [—(CH2CF2)-], hexafluoropropylene [—(CF2CF(CF3))-], tetra-fluoroethylene [—(CF2CF2)-], perfluorovinylmethyl ether [—(CF2CF(OCF3))-], and ethylene [—(CH2CH2)-]. Among the fluoroelastomers that may be used are fluoroelastomer copolymers comprising vinylidene fluoride and hexafluoropropylene, and terpolymers as well as tetra and higher polymers including vinylidene fluoride, hexafluoropropylene, and tetrafluoroethylene monomeric units. Additional suitable monomers include perfluorovinylalkyl ethers, such as perfluorovinylmethyl ether.

Preferred fluoroelastomers include random polymers comprising the following monomeric units:

—(CH2CF2)x-, —(CF2CF(CF3))y-, and —(CF2CF2)z-,

wherein
x is from about 30 to about 90 mole percent,
y is from about 10 to about 60 mole percent, and
z is from about 0 to about 42 mole percent.

Further preferred fluoroelastomers are random polymers comprising the following monomeric units:

—(CH2CH2)x-, —(CF2CF(OCF3))y-, and —(CF2CF2)z-,

wherein

x is from about 0 to about 70 mole percent,

y is from about 10 to about 60 mole percent, and

z is from about 30 to about 90 mole percent.

The fluoroelastomers, as discussed, may further include one or more cure site monomers. Among the suitable cure site monomers is 4-bromoperfluorobutene-1, 1,1-dihydro-4-bromo-perfluorobutene-1, 3-bromoperfluorobutene-1, and 1,1-dihydro-3-bromoperfluoropropene-1. When present, cure site monomers are generally in very small molar proportions. Preferably, the amount of cure site monomer will not exceed about 5 mole percent of the polymer.

Effective fluoropolymer cross-linking agents can include, e.g., any compound that is capable of reacting with and cross-linking fluoropolymers. Exemplary curing agents or cross-linkers can be bisphenol compounds. An exemplary bisphenol cross-linker can include VITON Curative No. 50 (VC-50) available from E. I. du Pont de Nemours, Inc. Curative VC-50 can contain Bisphenol-AF as a cross-linker and diphenylbenzylphosphonium chloride as an accelerator. Bisphenol-AF is also known as 4,4′-(hexafluoroisopropylidene)diphenol.

The fluoroelastomer molecular weight is largely a matter of convenience, and is not critical to the invention. However, as a matter of preference, the fluoroelastomers have a number average molecular weight of from about 10,000 to about 200,000. More preferably they have a number average molecular weight of from about 50,000 to about 100,000.

Among the fluoroelastomers that may be used are those that are plastic at ambient temperature and elastomeric at fusing or operating temperatures. Appropriate fluoroelastomers include those as identified in U.S. Pat. Nos. 4,372,246; 5,017,432; 5,217,837, and 5,332,641. These four patents are incorporated herein in their entireties, by reference thereto.

Commercially available fluoroelastomers which may be used are those sold under the trademark VITON by DuPont Dow Elastomers, Stow, Ohio. Also suitable are the TECHNOFLONS from Ausimont USA, Inc., Thorofare, N.J., and the FLUOREL fluoroelastomers from Dyneon L.L.C., Oakdale, Minn. Commercially available fluoroelastomer can include, for example, VITON A (copolymers of hexafluoropropylene (HFP) and vinylidene fluoride (VDF or VF2)), VITON-B, (terpolymers of tetrafluoroethylene (TFE), vinylidene fluoride (VDF) and hexafluoropropylene (HFP); and VITON-GF, (tetrapolymers including TFE, VF2, HFP)), as well as VITON E, VITON E 60C, VITON E430, VITON 910, VITON GH and VITON GF. Still other commercially available fluoroelastomer can include, for example, FLUOREL 2170, FLUOREL 2174, FLUOREL 2176, FLUOREL 2177 and FLUOREL LVS 76. Additional commercially available materials can include AFLAS (a poly(propylene-tetrafluoroethylene)) and FLUOREL II (LII900) (a poly(propylene-tetrafluoroethylenevinylidenefluoride)) both also available from 3M Company, as well as the TECHNOFLONS For-60KIR, For-LHF, NM, For-THF, For-TFS, TH, and TN505, available from Solvay Solexis. The VITON A, VITON GF, FE5840Q, and FX9038 fluoro-elastomers are particularly preferred.

Examples of polyperfluoroether elastomers include, e.g., SIFEL elastomers from SHIN-ETSU, and FLUOROLINK PFPE from Solvay Solexis. Such elastomers include the fluorocarbonsiloxanes comprising perfluoropolyether backbone terminated with a terminal silicone crosslinking group as described, e.g., in U.S. Pat. No. 5,641,568 and US Publication 2007/0237556, the disclosures of which are incorporated by reference herein.

The fusing surface layer may further include in addition to the fluoroplastic coated thermally conductive particles one or more additional fillers dispersed through the elastomer. Such additional fillers may be used for such purposes as improving toner offset and release properties of the fusing surface layer, controlling material properties such as wear resistance and surface roughness, modifying hardness, and imparting other characteristics, such as desired mechanical properties, to the fusing surface layer. Yet other additives and adjuvants also may be included in the fusing surface layer, as long as they do not affect the integrity thereof, or significantly interfere with an activity intended to occur in the layer, such as elastomer crosslinking. These further additives and adjuvants, where present, may be provided in amounts and proportions as are generally known or as can be determined without undue experimentation by those of ordinary skill in the art. Suitable examples include crosslinking agents, processing aids, accelerators, polymerization initiators, and coloring agents.

Particularly with respect to the toner fusing system and the toner fusing process and correspondingly the fuser member of the invention, the fuser base may be any of those as are known in the art. As a suitable embodiment, the fuser base may be a core in the form of a cylinder or a cylindrical roller, particularly a hollow cylindrical roller. In this embodiment the fuser base may be made of any suitable metal, such as aluminum, anodized aluminum, steel, nickel, copper, and the like. Also appropriate are ceramic materials and polymeric materials, such as rigid thermoplastics, and thermoset resins with or without fiber enforcement. Preferably the roller is an aluminum tube or a flame sprayed aluminum coated steel tube. Alternatively, the fuser base may be a plate. Materials suitable for the core may also be used for the plate.

One embodiment of a fuser base in the plate form is a curved plate mounted on a larger cylindrical roller that is, larger than a cylindrical roller which itself is employed as a fuser core. Being curved, the plate has the shape of a portion of a cylinder. Additionally, the plate can be mounted on the cylindrical roller, so that the plate can be replaced without also requiring replacement of the roller. In this embodiment, the properties discussed herein with reference to the fuser base pertain only to the portion of the cylindrical roller occupied by the attached plate; the rest of this roller is not involved in the fusing of toner to substrate.

In another alternative, the fuser base may be a belt, particularly an endless flexible belt. A thin belt made of a suitable metal, such as those indicated for the core and plate forms; the belt may also be made of a polyamide or a polyimide, particularly a heat resistant polyamide or polyimide. A polyimide material appropriate for the belt is commercially available under the trademark KAPTON, from DuPont High Performance Films, Circleville, Ohio.

Preferably the belt is mounted on rollers, which can be cores of the type as discussed herein. As a matter of preference two rollers are utilized with the belt, each of these two rollers defining a different one of the curves around which the belt passes.

A support member for the fusing system and process may be any of those as are known in the art; particularly, it can be a backup roller, also referred to as a pressure roller. The support member can be in the form of a roller, plate, or belt, in the same manner as is suitable for the fuser base; particularly, cores suitable for the fuser member may also be used for the support member. Where the support member is a belt, preferably it is mounted on rollers, in the same manner as for the fuser base in the form of a belt.

In any of the indicated forms, the support member may have mounted thereon a cushion for forming the nip with the fuser member. Suitable cushion materials include those having at least some degree of temperature resistance, such as silicone and EPDM elastomers.

Preferably, the fuser base is in the form of a cylindrical roller, with the fuser member correspondingly in the form of a roller specifically, a fuser roller. Also, as a matter of preference, the support member comprises a backup roller.

Further in the toner fusing system and process of the invention, internal heating and/or external heating may be employed. Heating means as are known in the art, such as appropriate heating members, are suitable. Preferably, the means of providing heat for fusing toner and substrate comprise the heating of the fuser member by one or more external and/or internal heating sources by one or more heating members and transmission of this heat from the fuser member to the toner, or to both toner and substrate preferably by contact.

As used herein with reference to heating, the terms “external” and “internal” pertain to positioning with respect to the fuser base. In this regard, “external” indicates location outside of the fuser base, and “internal” means residence within the fuser base.

Correspondingly, an external heating member is outside the fuser member, and therefore outside the fuser base. It provides heat to the fusing surface layer from outside the fuser member.

Consistent with the foregoing, an internal heating member is inside the fuser base, and correspondingly inside the fuser member. It accordingly provides heat to the fusing surface layer from within the fuser member.

Further as to the matter of heating, the term “primary” refers to providing more than 50%, and up to and including 100%, of the heat energy employed for fusing toner to the substrate on which it resides. Correspondingly, the term “secondary” refers to providing less than 50% of the heat energy.

Where there are one or more materials and/or layers, including one or more cushion layers, interposed between the fuser base and the fusing surface layer, they may be those as are known in the art. Where there is at least one cushion layer, the at least one cushion layer can include one or more thermally conductive cushion layers and/or one or more thermally nonconductive cushion layers. Generally, the thickness of the at least one cushion layer is about 20 millimeters or less, preferably from about 1 to about 10 millimeters.

Among the materials which can be used for the cushion layer are suitable silicone elastomers, such as appropriate thermally conductive silicone elastomers and thermally nonconductive silicone elastomers. Addition cure, condensation cure, and peroxide cure silicone elastomers can all be used, with addition cure silicone elastomers and condensation cure silicone elastomers being preferred.

Further, silicone elastomers formulated as liquid injection moldable (LIM), high temperature vulcanizate (HTV), and RTV silicone elastomers can be used. RTV and LIM silicones are preferred. Two particular silicone elastomers which may be used are SILASTIC J silicone and EC4952 silicone.

In a process that may be used for application of the cushion layer, the fuser base optionally can first be degreased and surface roughened. These functions may be accomplished by grit blasting. Except as discussed otherwise herein, the fuser base surface, whether or not initially degreased and roughened, is primed with conventional primer, such as DOW 1200 RTV Prime Coat Primer, from Dow Corning Corporation, and material for forming a cushion is subsequently applied thereto.

To form a silicone cushion layer, silicone elastomer is molded, particularly by injection, or extruded or cast onto the fuser base to the desired thickness. Curing is then effected. For a RTV silicone, this is accomplished by allowing it to sit at room temperature.

After curing, conventionally the silicone layer is subjected to a post cure, which improves compression set resistance. Typically a post cure is conducted at a temperature of around 150° C.-240° C., for a period of about 1-48 hours.

Before the fusing surface layer material is applied, the cushion material can be ground to a desired profile, depending upon the paper handling concerns to be addressed. For instance, a cylinder shape, or a crown, or barrel, or bow tie, or hourglass profile may be provided.

For preparation of the fusing surface layer, the fusing surface layer material is laid down either directly on the fuser base or on interposing material as indicated. This material is applied by any suitable means, as are known in the art, to form a layer of the requisite thickness, and then curing is affected also by any suitable means, as are known in the art.

There are factors to consider as to preferred maximum fusing surface layer thicknesses in various circumstances. For instance, if internal heating is employed in the fusing process, then the fusing surface layer must not be so thick as to impede heat transfer impermissibly, and thereby cause the base or core temperature to become excessive. Accordingly, even where the fusing surface layer is directly adjacent to the base, the layer preferably is not thicker than about 2,500 microns. Where external heating is employed and there is no internal heating, then the fusing surface layer can be thicker. In these circumstances the fusing surface layer can be as thick as about 15,000 microns, or even thicker; theoretically there is no thickness upper limit subject to considerations of cost and processing limitations. In either embodiment, thicknesses of around 100 microns are in any event generally sufficient to obtain the desired effects of the outermost layer.

Minimum thickness is also a matter to be considered. As one point, insufficient thickness of the fusing surface layer results in problems with respect to wearability. Layer thickness is accordingly typically at least 5 microns, and preferably at least 15 microns to resist abrasion, more preferably of at least about 35 microns, and still more preferably of at least about 45 microns. In a preferred embodiment, the fusing surface layer has a thickness of from about 5 microns to about 2,500 microns, more preferably 5 to 100 microns, and still more preferably 15 to 100 microns.

The fuser member of the invention can be used in toner fusing systems and processes where, during operation, release agent is applied to the fusing surface layer so that this agent contacts toner on the substrate and can also contact the substrate during the operation of the fuser member. Particularly where the fuser base is a cylindrical roller or an endless belt, the release agent is applied while the base is rotating or the belt is running upstream of the contact area between fuser member and substrate toner.

If employed, release agent preferably is applied so as to form a film on the fusing surface layer. As a matter of particular preference, the release agent is applied so as to form a film that completely covers the fusing surface layer. Also as a matter of preference, during operation of the system the release agent is applied continuously to the fusing surface layer.

Release agents are intended to prohibit, or at least lessen, offset of toner from the substrate to the fusing surface layer. In performing this function, the release agent can form, or participate in the formation of, a barrier or film that releases the toner. Thereby the toner is inhibited in its contacting of, or even prevented from contacting the actual fusing surface layer.

The release agent can be a fluid such as an oil or a liquid and is preferably an oil. It can be a solid or a liquid at ambient temperature and a fluid at operating temperatures. Preferred release agents are those that cause minimal swell of the fuser member elastomer layer.

Suitable release agents are those disclosed in U.S. Pat. Nos. 5,824,416; 4,515,884 and 5,780,545. These three patents are incorporated herein in their entireties by reference thereto.

Commercially available polydimethylsiloxanes which may be used as release agents are the DC200 polydimethylsiloxanes, from Dow Corning Corporation.

Also suitable are hydrocarbon release agents, particularly polyethylene release agents. Polyethylene release agents which may be used include those that are solid at 25° C., but liquid at operating temperatures, particularly fusing process temperatures. Preferred polyethylenes are those having a molecular weight of from about 300 to about 10,000.

Yet additionally suitable are perfluoropolyether release agents. Commercially available perfluoropolyethers that are suitable for use as release agents include the following: KRYTOX, from E.I. du Pont de Nemours and Company, Deepwater, N.J.; FOMBLIN Y45, YR, and YPL1500, from Ausimont USA, Inc., Thorofare, N.J.; and GALDEN HT230, HT250, HT270, also from Ausimont USA, Inc.

The release agent may be applied to the fuser member by any suitable applicator, including sump and delivery roller, jet sprayer, etc. Those means as disclosed in U.S. Pat. Nos. 5,017,432 and 4,257,699 may be employed; the latter of these two patents is incorporated herein in its entirety, by reference thereto. The present invention employs a rotating wick oiler or a donor roller oiler.

A rotating wick oiler comprises a storage compartment for the release agent and a wick for extending into this compartment. During the operation of the toner fusing system of the invention, the wick is situated so as to be in contact with the stored release agent and also with the fusing surface layer of the fuser member; the wick picks up release agent and transfers it to the fuser member.

A donor roller oiler includes two rollers and a metering blade, which can be a rubber, plastic, or metal blade. One roller meters the oil in conjunction with the blade, and the other transfers the oil to the fuser roller. This type of oiler is common in the art, and is frequently used with fuser members having fluoroelastomer fusing surface layers.

The release agent is applied to the substrate, particularly in the case of paper, preferably at a rate of from about 0.1 to about 20 microliters, more preferably at a rate of about 1.0 to about 8 microliters, per 8½″ by 11″ copy. The applicator is adjusted accordingly to apply the release agent at this rate.

### Experimental Procedures

### Preparation of Treated Powders

### EXAMPLE A

### Solvent Coated

An amount of 1 gram of TEFLON AF (DuPont) was dissolved in 50 grams FLUORINERT (3M Company) fluorinated solvent and combined with 33.33 g R9998 (2.5 micron Fe203 powder from Harcros Pigments Inc.). The resulting powder was dried overnight in a hood, resulting in fluoroplastic coated iron oxide particles.

### EXAMPLES B-F

### Sinter Coated

Example B: 5 grams R9998 blended with 0.25 g ZONYL MP1100 (LMW polytetrafluoroethylene), and sintered at 700° F. for 5 minutes.

Example C: 5 grams R9998 blended with 0.5 g MP1100, and sintered at 700° F. for 5 minutes.

Example D: 5 grams R9998 blended with 0.75 g MP1100, and sintered at 700° F. for 5 minutes.

Example E: 5 grams R9998 blended with 1.0 g MP1100, and sintered at 700° F. for 5 minutes.

Example F: 5 grams R9998 blended with 1.5 g MP1100, and sintered at 700° F. for 5 minutes.

A wettability test was performed to evaluate the surface energy and relative coverage of the coated powders. The test is performed by preparing a mixture series of deionized water and ethanol in 20 ml scintillation vials, and adding a tenth of a gram of powder to the surface of the solution. The behavior of the powder at the air-water interface is an indication of well the test solution wets the powder, with uncoated powders easily wet by all test solutions, and well coated powders displaying the same wettability of the pure Teflon powders. Particles that are not wet will remain clumped at the air water interface, while particles that show progressively more wetting will spread at the air water interface and ultimately sink into the solution when the wetting is high enough.

TABLE 1

| | | 37.5% | 50% | 62.5% | 75% |
|---|---|---|---|---|---|
| | MP1100* | Ethanol | Ethanol | Ethanol | Ethanol |
| Example B | 5 pph | 1 | 5 | 6 | Not tested |
| Example C | 10 pph | 2 | 3 | 6 | 7 |
| Example D | 15 pph | 0 | 2 | 4 | 6 |
| Example E | 20 pph | Not tested | 1 | 3 | 6 |
| Example F | 30 pph | Not tested | 0 | 2 | 4 |
| Pure | na | Not tested | Not tested | 2 | 4 |
| MP1100 | | | | | |

*Parts of fluoroplastic treatment per 100 parts inorganic filler
Rating Scale:
0—no wetting no spreading
1—slight surface spreading of powder
2—some spreading of the powder on the surface
3—Complete spreading of the powder on the surface
4—Complete spreading of the powder on the surface with trace particles fully wet and sinking to the bottom of the vial
5—Complete spreading of the powder on the surface with some (up to 10%) particles fully wet and sinking to the bottom of the vial
6—Complete spreading of the powder on the surface with significant (up to 50%) particles fully wet and sinking to the bottom of the vial
7—Complete spreading of the powder on the surface with most (over to 90%) particles fully wet and sinking to the bottom of the vial

The results in Table 1 show the coated filler has a much lower surface energy as exhibited by the dramatically reduced wetting of water alcohol mixtures, and the surface energy lowers as the amount of coating is increased. At approximately 30 parts fluoroplastic per hundred part of filler, the particles behave identically to pure fluoroplastic powder with no wetting by a 50% ethanol water mixture and only some spreading at the air-water interface on a 62.5% ethanol mixture. Thus using the coated fillers of this invention one can obtain the benefits of the non-stick behavior of fluoroplastic powder, yet have the thermal conductivity of inorganic fillers.

### Preparation of Fuser Rollers:

### COMPARATIVE EXAMPLE 1

Combined 30 grams of SIFEL 610 part A, a platinum catalyzed crosslinkable perfluoropolyether available from ShinEtsu Silicones, and 30 grams SIFEL 610 part B, and 69.3 grams of R9998 iron oxide and milled on a three roll mill for approximately 5 to 10 minutes. A cylindrical aluminum core was degreased and primed with a uniform coat of DOW 1200 RTV Primer. SILASTIC J silicone rubber was then mixed with catalyst and injection molded onto the core, and cured at 232° C. under pressure. The roller was removed from the mold, postcured, and ground. The ground cushion was cleaned with IPA, and plasma-jet treated 2 passes. Using the blended material from the three roll mill, blade coated 30 grams of the mixture onto the cushion. Placed the coated roller into an oven and ramped the oven to 150° C. over 12 hours, then cured the roller at 150° C. for 1 hour. The roller was ground such that the coated layer was approximately 4 mils thick.

### COMPARATIVE EXAMPLE 2

Combined 25 grams of SIFEL 610 part A, 25 grams of SIFEL 610 part B, and 67.2 grams of R9998 iron oxide and milled on a three roll mill for approximately 5 to 10 minutes. The mixture was then placed under vacuum and de-gassed for 90minutes. A cushion was prepared as in Comparative Example 1, and using the blended material from the three roll mill, blade coated 30 grams of the mixture onto the cushion. Placed the coated roller into an oven and ramped the oven to 150° C. over 12 hours, then cured the roller at 150° C. for 1 hour. The roller was ground such that the coated layer was approximately 4mils thick.

### EXAMPLE 1

Combined 50 grams of R9998 with 10 g of MP1100 fluoroplastic in a small blender and mixed on low for 30 sec, then increased to high for 30 sec. Manually stirred the contents of the blender to mix in any dead spots, and re-blended for 30 sec on high. Placed the blended powder in an aluminum pan and baked in an oven at 700° F. for 5 minutes to melt the fluoroplastic and coat the iron oxide particles. The resulting powder is 16.7 wt % fluoroplastic. Combined 25 grams of SIFEL 610 part A, 25 grams of SIFEL 610 part B, and 84.7 grams of the MP 1100 coated R9998 iron oxide and milled on a three roll mill for approximately 5 minutes. A cushion was prepared as in Comparative Example 1, and using the blended material from the three roll mill, blade coated 30 grams of the mixture onto the cushion. Cured the roller at 150° C. for 1 hour. The roller was ground such that the coated layer was approximately 4 mils thick.

### EXAMPLE 2

The roller of Example 2 was prepared substantially the same as Example 1 except that 20 grams of MP 1100 was combined with 50 grams of R9998 during the initial dry blending step, and the resulting powder is 28.6% fluoroplastic.

The rollers of Examples 1 and 2 and Comparative Examples 1 and 2 were place into a DIGIMASTER 9110 printer modified by replacing the standard release fluid with a PFPE functional oil comprising 0.5 wt. % of FLUOROLINK 7004 (a mono-terminated carboxylic acid perfluoropolyether supplied by Ausimont) to the standard stabilized DIGIMASTER release fluid. The rollers were then run at two temperatures (365 and 380° F.) and the fusing quality and contamination performance were evaluated. Fusing quality, or AC W, is evaluated by folding a sheet of 20# bond with a Dmax toned patch such that the fold passes through the toned patch. The sheet is unfolded and the width of the resulting crack is measured in microns by image analysis. The contamination performance is evaluated by running an in track density step target on 20# bond and measuring the corresponding locations on a cleaning web that cleans the external heater rollers. The maximum density as measured by transmission density is reported as Web Dt. The average of the transmission density for all of the density steps is reported as Average Web Dt. The results are shown in Table 2.

TABLE 2

| | | Filler | | | | | |
|---|---|---|---|---|---|---|---|
| | | Fluoro | | | | | |
| | | plastic | | ACW | ACW | | |
| Fuser | % Filler | Treatment | Temp | 20# | 80# | Web | Average |
| Roller | (by vol.) | (wt %) | (° F.) | SS | SS | Dt | Web Dt |
| Comp Ex 1 | 27 | 0 | 380 | 49.7 | 133.1 | 0.85 | |
| Comp Ex 1 | 27 | 0 | 365 | 102.7 | 299.7 | 1.08 | 0.965 |
| Comp Ex 2 | 31 | 0 | 380 | 37.4 | 128.8 | 0.88 | |
| Comp Ex 2 | 31 | 0 | 365 | 62.3 | 178 | 0.97 | 0.925 |
| Example 2 | 27 | 28.6 | 380 | 42.3 | 114 | 0.57 | |
| Example 2 | 27 | 28.6 | 365 | 78 | 195 | 0.7 | 0.635 |
| Example 1 | 31 | 16.7 | 380 | 15.9 | 113.3 | 0.65 | |
| Example 1 | 31 | 16.7 | 365 | 54.7 | 175.3 | 0.82 | 0.735 |

The results in Table 2 show that the Web Dt of the rollers of example 1 and example 2 are significantly lower than the rollers without the coating demonstrating improved resistance to toner offset. Additionally, the fusing quality as defined by ACW is relatively unchanged or slightly better.

The invention has been described in detail with particular reference to certain preferred embodiments thereof, but it will be understood that variations and modifications can be effected within the spirit and scope of the invention.

1. A fuser member having as its outermost layer, a cured composite comprising:
a) a continuous phase of an elastomer; and
b) thermally conductive particles dispersed in the elastomer phase, where the conductive particles comprise inorganic particles coated with a layer of fluoroplastic.

2. The fuser member according to claim 1, wherein the inorganic particles have a thermal conductivity greater than 0.5 Watts/mK.

3. The fuser member according to claim 1, wherein the inorganic particles are selected from the group consisting of SnO₂, SiC, CuO, ZnO, FeO, Fe₂O₃, BN, crystalline SiO₂, TiO₂, and Al₂O₃ particles.

4. The fuser member according to claim 1, wherein the inorganic particles comprise Al₂O₃ or Fe₂O₃ particles.

5. The fuser member according to claim 1, wherein the inorganic particles comprise Fe₂O₃ particles.

6. The fuser member according to claim 1, wherein the thermally conductive particles are present in volume percent of 5 to 45.

7. The fuser member according to claim 1, wherein the elastomer comprises a fluoroelastomer.

8. The fuser member according to claim 7 wherein the fluoroelastomer is selected from the group consisting of vinylidene fluoride based fluoroelastomers containing hexafluoropropylene; terpolymers of vinylidene fluoride, hexafluoropropylene and tetrafluoroethylene; and crosslinked perfluoropolyether elastomers.

9. The fuser member of claim 1 wherein the fluoroplastic comprises a polytetrafluoroethylene, a fluorinated ethylene propylene, a copolymer of tetrafluoroethylene and hexafluoropropylene, a copolymer of tetrafluoroethylene and ethylene, or a copolymer of tetrafluoroethylene and perfluoroalkyl vinyl ether.

10. The fuser member of claim 1 wherein the fluoroplastic coated particles comprise 5 to 75 percent fluoroplastic coating by weight.

11. The fuser member according to claim 1 comprising a core, a base cushion layer overlying the core, and the outermost layer.

12. The fuser member according to claim 11 wherein the base cushion layer comprises a condensation cured polydimethylsiloxane.

13. The fuser member of claim 1 wherein the outermost layer has a thickness of 5 to 100 microns.

14. A process for fusing thermoplastic toner residing on a substrate to the substrate, the process comprising:
(a) heating a fuser member according to claim 1 to a temperature of from about 90° C. to about 250° C.; and
(b) contacting the toner with the heated fusing member.

15. The process of claim 14, further comprising applying a release agent to the fusing surface layer of the fuser member.
